(19) United States
(12) Patent Application Publication
(10) Pub. No.: US 2026/0326617 A1
(43) Pub. Date: Oct. 22, 2026

(54) Method for Operating a Motor Vehicle, and Motor Vehicle

(71) Applicant: Bayerische Motoren Werke Aktiengesellschaft, Muenchen (DE)

(72) Inventors: Lukas BERNHAUSER, Ottensheim (AT); Christoph BOHLAND, St. Valentin (AT); Sebastian HAHN, Schwertberg (AT); Stefan HOFMANNINGER, Weibern (AT); Dominik MOSER, Linz (AT); Fisnik SULEJMANI, Linz (AT)

(21) Appl. No.: 19/109,671

(22) PCT Filed: Aug. 4, 2023
(86) PCT No.: PCT/EP2023/071713

§ 371 Date: Mar. 7, 2025

(30) Foreign Application Priority Data
Sep. 8, 2022 (DE) 10 2022 122 765.0

(51) Int. Cl. B60L 58/26; B60L 58/12; B60L 58/27; H01M 10/46; H01M 10/613; H01M 10/615; H01M 10/625; H01M 10/635; H01M 10/6556; H01M 10/667

(52) U.S. Cl. CPC B60L 58/26; B60L 58/12; B60L 58/27; H01M 10/46; H01M 10/613; H01M 10/615; H01M 10/625; H01M 10/635; H01M 10/6556; H01M 10/667; B60L 2240/545; H01M 2220/20

(57) ABSTRACT

The present disclosure relates to a motor vehicle and a method for operating a motor vehicle, having a traction battery, having a charging device for charging the traction battery with alternating current, and an ambient heat exchanger of a cooling circuit of a cooling device through which different cooling circuits can be formed, wherein during charging of the traction battery by the charging device, a charging cooling circuit is formed as one of the cooling circuits through which charging cooling circuit heat is absorbed from a charging heating element connected in a heat-conducting manner to the charging device and is transferred to a traction heating element connected in a heat-conducting manner to the traction battery and there is no heat exchange with the ambient heat exchanger.

### BACKGROUND AND SUMMARY

The present disclosure relates to a motor vehicle and a method for operating a motor vehicle.

Electrically drivable motor vehicles usually have a traction battery. This can be charged by a suitable charging infrastructure, it being possible to charge with alternating current and with direct current. While doing so, 7.4 kilowatt, 11 kilowatt and 22 kilowatt charging power are commonly used as standard. During charging, heat arises in a vehicle-side charging device, for example due to electrical resistances.

This heat arising at the charging device is dissipated via a vehicle cooler which exchanges heat with an ambient area, in particular an ambient air, of the motor vehicle. Furthermore, DE 10 2018 110 396 A1 shows a direct-current rapid-charging and air-conditioning control system for hybrid electric vehicles. The disadvantage is, for example, that the heat arising in the charging device during charging is dissipated to the ambient area unused.

An object of the present disclosure is to provide a method and a motor vehicle, by way of which a traction battery of the motor vehicle can be charged with alternating current particularly efficiently.

This object is achieved by the subject matter of the present disclosure. Advantageous configurations and developments are the subject matter of the description and the drawings.

A first aspect of the present disclosure relates to a method for operating a motor vehicle, in particular in the form of a passenger car. The method according to the present disclosure is used to operate the motor vehicle having a traction battery, having a charging device for charging the traction battery with alternating current, and an ambient heat exchanger of a cooling circuit of a cooling device by way of which different cooling circuits are able to be formed or able to be interconnected, wherein, when the traction battery is being charged by the charging device, a charging cooling circuit is formed as one of the cooling circuits, by way of which charging cooling circuit heat is absorbed from a charging heating element connected in a heat-conducting manner to the charging device and is transferred to a traction heating element connected in a heat-conducting manner to the traction battery and there is no heat exchange with the ambient heat exchanger, or in particular between the charging heating element and the ambient heat exchanger, while doing so.

The ambient heat exchanger may, for example, be a vehicle cooler which exchanges heat with an ambient area of the motor vehicle, in particular with an ambient air. The cooling circuits of the cooling device are flown through by coolant. The traction battery comprises, for example, a plurality of battery cells or cells and is used to drive an electric drive of the motor vehicle. The charging device is designed to convert alternating current, which is provided via a charging line of a source external to the vehicle, into a direct voltage or a direct current suitable for charging the battery. The charging heating element may in particular be a heat exchanger and/or be, for example, in the form of a housing, in particular made of metal, which at least partially surrounds the charging device and has openings through which coolant of the cooling device can flow. The traction heating element is, for example, likewise a heat exchanger which is designed to exchange heat between the traction battery and the cooling device.

In other words, the method according to the present disclosure encompasses a motor vehicle which comprises a traction battery that is connected in a heat-exchanging manner to a cooling device via a traction heating element, and which comprises a charging device by which alternating current is converted into direct current and is able to be provided as charging current for the traction battery and which is connected in a heat-conducting manner to the cooling device via a cooling element, wherein the cooling device comprises a vehicle cooler and, for example, a switching device by which different cooling circuits are able to be switched, wherein, when the traction battery is being charged by the charging device, a cooling circuit is formed in such a way that heat is absorbed at the cooling element and is transferred to the traction heating element and there is no heat exchange with the vehicle cooler while doing so. The waste heat arising in the charging device during charging, for example due to electrical resistances, is not transferred to an ambient area of the vehicle via the vehicle cooler but is in particular used to apply heat to the traction battery.

Thus, in contrast to the waste heat being removed via the vehicle cooler, the waste heat is, during the charging with alternating current, purposefully and efficiently transported into a storage device or the traction battery and, in addition or alternatively, into the vehicle interior, and used.

This results in several advantages. The waste heat of the charging device, which in particular is in the form of a central control unit, is thus used intelligently, as a result of which active heating of the storage device can be advantageously avoided. Also made possible is an increase in a discharging power after the charging with alternating current in the storage device which in particular is in the form of a high-voltage storage device. Furthermore, the advantage arises that a particularly high cell temperature of the cells in the fraction battery on departure is made possible even for relatively long stationary phases. Moreover, it can result in the reduction in the cell spreading, in particular for a departure, this allowing an increase in the life of the traction battery to be achieved. Likewise, the method can be used to achieve an increase in a temperature collective of the high-voltage storage device, this likewise resulting in a particularly long life. In addition, it is possible to avoid separate heating of the high-voltage storage device or of the traction battery after the charging operation, as a result of which the motor vehicle can be operated particularly efficiently. Moreover, the thermal level of the storage device can be used purposefully for heat pump operation, which likewise results in particularly high efficiency during operation of the motor vehicle. Furthermore, the charging with alternating current can be used for active interior heating in order to heat the interior, as a result of which particularly efficient operation of the motor vehicle is likewise made possible. Overall, the waste heat arising due to the charging with alternating current during the charging operation is used advantageously.

In one advantageous configuration of the present disclosure, when the traction battery is being charged, an interior heating element or a passenger compartment heating element is arranged in the charging cooling circuit with the charging heating element and the traction heating element. In other words, the cooling circuit is formed by the cooling device or is interconnected in such a way that the interior heating element, which for example constitutes a chiller or a heater of the vehicle interior, can, during the charging process, be supplied with the waste heat which arises at the charging device. The advantage therefore arises that, when the vehicle interior needs to be heated, this can be carried out particularly efficiently by the method such that heat generated during charging is not removed into an ambient area of the vehicle but heats the vehicle interior.

In another advantageous configuration of the present disclosure, the charging cooling circuit of the cooling device is formed or interconnected in dependence on an ambient temperature and/or a battery temperature and/or an interior temperature. In other words, the charging cooling circuit is formed temperature-dependently, wherein various temperatures come into consideration. Use can thus firstly be made of the ambient temperature, that is to say in particular an outside air temperature or a temperature of the ambient area in which the vehicle is located. The charging cooling circuit can thus be formed, for example for a particularly low temperature, in order to heat the traction battery. Conversely, for particularly high temperatures for which a battery temperature of the traction battery for example already lies in a temperature range needed for advantageous operation of the traction battery or of the motor vehicle, it is possible to revert back to conventional charging during the charging process such that waste heat is dissipated via the vehicle cooler and is not used for warming the traction battery. In addition or altematively, the charging cooling circuit may depend on the interior temperature of the vehicle interior such that the charging cooling circuit can be used for heating the vehicle interior. One implementation may be that the charging cooling circuit is formed in such a way that predominantly the interior heating element is supplied with waste heat of the charging device and the traction heating element is only slightly or not at all supplied with heat of the charging device. This results in the advantage that appropriate, particularly advantageous charging can be reverted to in dependence on the mentioned temperatures.

In another advantageous configuration of the present disclosure, an extended charging cooling circuit in which the ambient heat exchanger is arranged is formed in dependence on the ambient temperature and/or the battery temperature and/or the interior temperature. In other words, the charging cooling circuit, which is formed by the charging heating element and the traction heating element and for example also the interior heating element, can additionally integrate the ambient heat exchanger which is not originally provided. This may be useful for example when the battery temperature has already reached a certain temperature such that if any further heat were supplied from the charging heating element via the traction heating element, for example, the temperature range suitable for advantageous operation of the traction battery would be exceeded. The ambient heat exchanger can thus be included in order to maintain particularly high efficiency and at the same time to avoid overheating. The advantage therefore arises that the method can be used particularly advantageously for operating the motor vehicle.

In another advantageous configuration of the present disclosure, the charging cooling circuit and/or the extended charging cooling circuit are/is formed in dependence on a state of charge of the traction battery. In other words, the state of charge, SoC for short, of the battery is considered in relation to its capacity, and the charging cooling circuit or the extended charging cooling circuit is formed accordingly. The result is that, for example, as the state of charge increases, the traction battery is charged with decreasing charging power in order to keep the life thereof particularly long. Therefore, for example, if it is possible to reduce the required charging power based on the state of charge of the traction battery, the waste heat may no longer need to be applied to the traction heating element; this can advantageously be taken into account by the method. This results in the advantage that the traction battery can be charged particularly advantageously and for example sparingly.

In another advantageous configuration of the present disclosure, the charging cooling circuit and/or the extended charging cooling circuit are/is formed in dependence on a planned change in operating state of the motor vehicle. In other words, the charging cooling circuit and/or the extended charging cooling circuit are connected if a change in the operating state of the motor vehicle is intended. The change in operating state may be in particular transferring the parked or charging motor vehicle into a driving mode. Provision may thus be made, for example, for the motor vehicle to be started at a certain time and this information is stored, for example, in a control device which in particular is connected to or controls the charging device for the purpose of exchanging information. By using this information, the traction battery can then advantageously reach its operating temperature at the appropriate time by way of the method. This can be achieved or at least taken into account through corresponding formation of the charging cooling circuit or of the extended charging cooling circuit during charging. This results in the advantage that the motor vehicle can be operated particularly advantageously.

In another advantageous configuration of the present disclosure, the charging cooling circuit and/or the extended charging cooling circuit are/is formed in dependence on a charging power provided by the charging device. In other words, the charging cooling circuit and/or the extended charging cooling circuit are/is formed in dependence on the actual charging power made available to the charging device from a wallbox, for example. For a particularly high provided charging power, the extended charging cooling circuit can thus be formed, whereas for a low charging power, for example, only the charging cooling circuit is formed. This results in the advantage that the motor vehicle can be charged particularly advantageously.

In another advantageous configuration of the present disclosure, the charging cooling circuit and/or the extended charging cooling circuit are/is formed in dependence on at least one for example thermal cell spreading of at least one cell of the traction battery. In other words, the traction battery comprises a plurality of cells or battery cells which are in particular monitored for example by a battery management system such that the cell voltage and a plurality of cell temperatures can be known from individual cells. If different temperatures occur in one cell, cell spreading, which shortens the life of the battery, can occur depending on the temperature gradient thus prevailing in the cell. This can be avoided or reduced through controlled charging using the presented method such that the charging cooling circuit or the extended charging cooling circuit is formed in dependence on the cell spreading. This results in the advantage that the traction battery can be charged in such a way that its life is particularly long.

In another advantageous configuration of the present disclosure, the different charging cooling circuits of the cooling device, in particular the charging cooling circuit and/or the extended charging cooling circuit, are formed by at least one valve, i.e. the corresponding cooling circuit is formed by this valve. In other words, the cooling device comprises at least one valve which is arranged in such a way that lines through which coolant flows of the individual heating elements, that is to say the traction heating element, the charging heating element and/or the interior heating element and the ambient heat exchanger, are able to be interconnected to each other via the at least one valve. The cooling device can therefore be designed particularly simply and thus without many components and/or flexibly. This results in the advantage that the method can be carried out particularly simply.

A second aspect of the present disclosure relates to a motor vehicle having a traction battery. The motor vehicle according to the present disclosure comprises a traction battery and a charging device for charging the traction battery with alternating current, and an ambient heat exchanger for exchanging heat with a cooling circuit of a cooling device by way of which different circuits are able to be formed, wherein, when the traction battery is being charged by the charging device, a charging cooling circuit is formed, by way of which charging cooling circuit heat is able to be absorbed from a charging heating element connected in a heat-conducting manner to the charging device and is able to be transferred to a traction heating element connected in a heat-conducting manner to the traction battery and there is no heat exchange with the ambient heat exchanger while doing so. Advantageous configurations and developments of the first aspect of the present disclosure are considered to be advantageous configurations and developments of the second aspect of the present disclosure, and vice versa.

Further features of the present disclosure are evident from the figures and the description of the figures. The features and combinations of features mentioned above in the description, and the features and combinations of features mentioned below in the description of the figures and/or shown in the figures themselves, cannot only be used in the respectively specified combination but also in other combinations or by themselves.

The present disclosure will now be explained in more detail based on exemplary embodiments and with reference to the drawings.

### BRIEF DESCRIPTION OF THE DRAWINGS

FIG. 1 shows a schematic view of a motor vehicle having a traction battery, charging apparatus and cooling device, which vehicle performs a method for charging the traction battery;

FIG. 2 shows a schematic view of the motor vehicle according to FIG. 1, wherein an advantageous method for charging the battery is carried out;

FIG. 3 shows a schematic view of the motor vehicle according to FIG. 2, wherein an alternative embodiment of the advantageous method is carried out; and

FIG. 4 shows a schematic diagram showing operating states of the advantageous method.

### DETAILED DESCRIPTION OF THE DRAWINGS

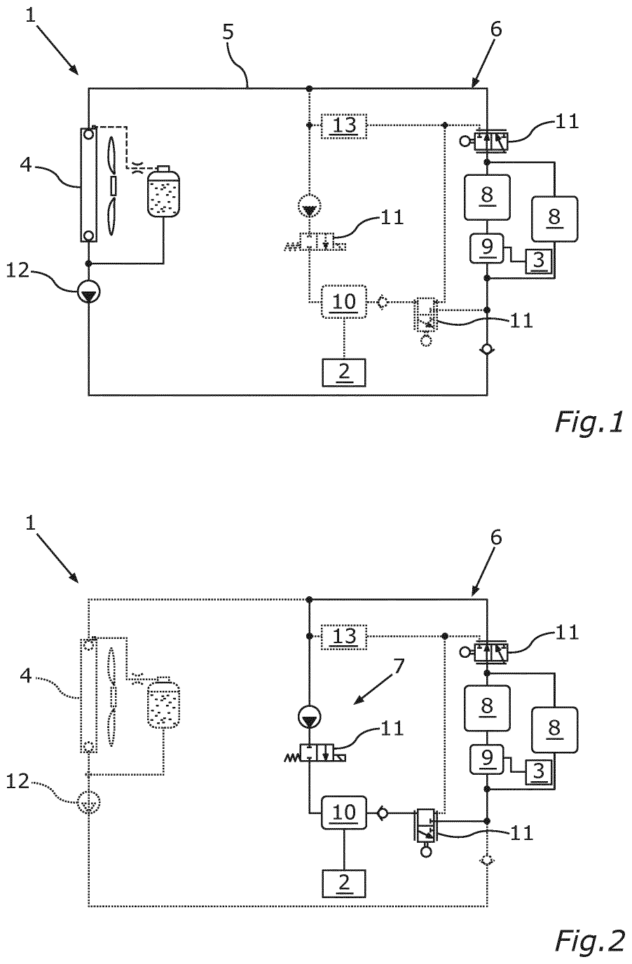

FIG. 1 shows a schematic view of a motor vehicle 1 having a traction battery 2, having a charging device 3 for charging the traction battery 2, and an ambient heat exchanger 4 for exchanging heat with an ambient area of a cooling circuit 5 of a cooling device 6 by way of which different cooling circuits 5, 7 are able to be formed or able to be interconnected.

In the motor vehicle 1, an electrical drive train 8 for a front and a rear axle are each driven by electrical energy provided by the fraction battery 2. The traction battery 2 can be charged by the charging device 3 by alternating current, wherein heat arises in the charging device 3 due to electrical resistances and conversion into direct current, for example, which heat needs to be dissipated.

In order to dissipate the heat, use is made of a charging heating element 9 which, for example, is in particular formed as a housing, which is able to be flown through by coolant, of the charging device 3. Heat is then transferred to the cooling circuit 5 via this charging heating element. This heat is absorbed by the ambient heat exchanger 4 and transferred to an ambient area of the motor vehicle 1.

Interconnection or formation of the cooling circuits 5 and 7 of the cooling device 6 is illustrated in FIG. 1 to FIG. 3 using non-dashed lines so as to make the respectively connected or formed cooling circuit 5 clear. The dashed region is currently not in use as a cooling circuit.

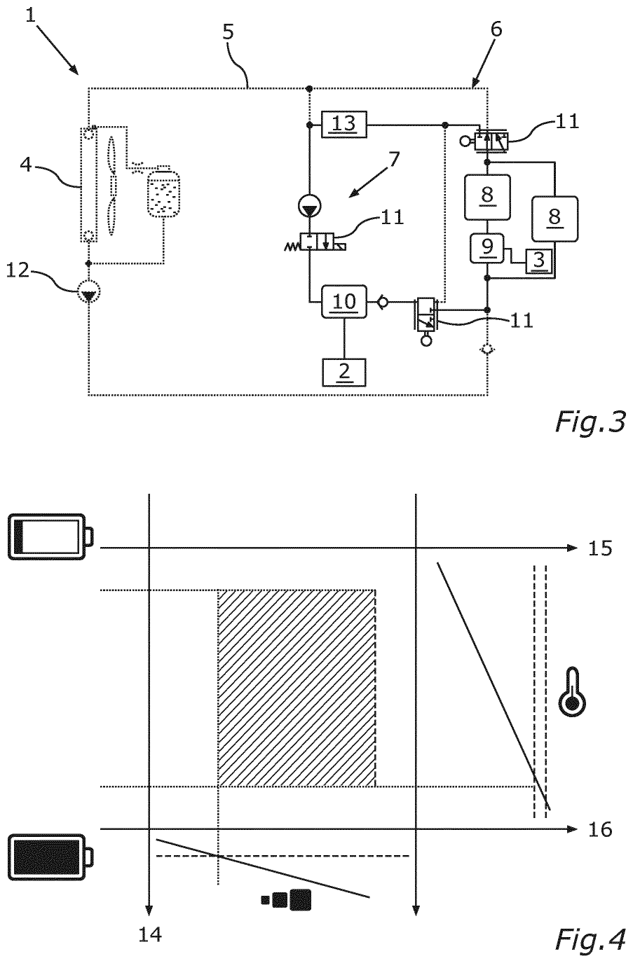

In order that the traction battery 2 can then be advantageously charged and the motor vehicle 1 can be advantageously operated, in addition to the motor vehicle I a method for operating the motor vehicle 1 is furthermore presented, in which method, when the traction battery 2 is being charged by the charging device 3, a charging cooling circuit 7 is formed, by way of which charging cooling circuit heat is absorbed from a charging heating element 9 connected in a heat-conducting manner to the charging device 3 and is transferred to a traction heating element 10 connected in a heat-conducting manner to the traction battery 2, and there is no heat exchange with the ambient heat exchanger 4 while doing so, cf. FIGS. 2 and 3.

The respective cooling circuit 5, 7 is in particular a line which is able to be flown through by a coolant and which is connected to the ambient heat exchanger 4, the charging heating element 9 and/or the traction heating element 10. Pumps 12 can be provided for conveying the coolant. In order to form or to connect respective cooling circuit topologies by way of the cooling device 6 in a particularly advantageous way, provision is advantageously made for at least one valve 12 by way of which the cooling circuit 5 or the charging cooling circuit 7 according to FIG. 2 or FIG. 3 and an extended charging cooling circuit can be connected.

The method for operating the motor vehicle 1 and thus the formation of the charging cooling circuit 7 can be advantageously carried out in dependence on an ambient temperature and/or a battery temperature of the traction battery 2 and/or an interior temperature of the vehicle interior of the motor vehicle 1.

It can thus be advantageous if the traction battery 2 is operated in a temperature range which for example delimits optimally particularly advantageous charging temperatures and/or particularly advantageous operating temperatures such that, if the temperature of the traction battery 2 is already at an upper end of the temperature range, conventional charging may be preferred.

Moreover, it may be possible, for example, to heat the vehicle interior in dependence on the interior temperature, for which an interior heating element 13, which is formed by a chiller, for example, is heated such that, in the presented method, such as shown in FIG. 3, the charging cooling circuit 7 is formed in such a way that, when the fraction battery 2 is being charged, the interior heating element 13 is arranged in the charging cooling circuit 7 with the charging heating element 9 and the traction heating element 10 such that waste heat of the charging device 3 can be transferred via the charging heating element 9 to the traction heating element 10 and the inferior heating element 13.

The presented method which allows the two charging cooling circuits 7 shown in FIGS. 2 and 3 gives rise to several advantages. Firstly, the waste heat of the charging device 3, which in particular is in the form of a central control unit (CCU), can thus be used intelligently, wherein the waste heat is formed by charging with alternating current with, for example, 7.4, 11 or 22 kilowatt. Active heating of the storage device can be avoided with, for example, an electrical auxiliary heater and/or an increased power loss of the traction machines during charging with alternating current. An increase in the discharging power after the charging with alternating current thus arises at the traction battery 2. Furthermore, an increased cell temperature on departure is possible even after relatively long stationary phases. The cell temperatures correspond to the temperatures of the cells of the traction battery 2.

Moreover, a reduction in the cell spreading, in particular when the motor vehicle 1 starts driving, is possible. The formation of the charging cooling circuit 7 and/or of an extended charging cooling circuit 7 can thus be carried out in dependence on at least one cell spreading of at least one of the cells of the traction battery 2. It has been shown that an extended charging cooling circuit can be formed in dependence in particular on one of the temperatures, that is to say the cell temperature or battery temperature and/or the ambient temperature also in combination with the interior temperature, in which charging cooling circuit the ambient heat exchanger 4 is arranged such that, in addition to the advantageous interconnection of the two heating elements (in particular the charging heating element 9 and the traction heating element 10), heat can additionally be carried out via the ambient heat exchanger 4 in particular in the form of a vehicle cooler.

Furthermore, it is advantageous if the charging cooling circuit 7 and/or the extended charging cooling circuit are/is formed in dependence on a state of charge of the traction battery 2. In addition or alternatively, the charging cooling circuit 7 and/or the extended charging cooling circuit may be formed in dependence on a planned change in operating state of the motor vehicle 1. Moreover, the charging cooling circuit 7 and/or the extended charging cooling circuit 7 may be formed in dependence on a charging power provided by the charging device 3.

An advantageous range for the charging presented by the method or the operation of the motor vehicle 1 based on the alternating-current charging produced by the charging device 3 is summarized schematically in the diagram of FIG. 4.

The diagram shows one possible charging process, in particular while the chiller, that is to say the interior heating element 13, is bypassed or circumvented, and the cooling circuit 7 according to FIG. 2 is thus connected.

The first axis 14 pointing downward shows the state of charge of the traction battery 2, wherein a lower state of charge SoC A and an upper state of charge SoC B are shown. Between these two states of charge is a range in which the presented method can be carried out particularly advantageously for charging the traction battery 2 by the charging device 3 by alternating current. The upper of the two horizontal axes 15 shows the temperature of the traction battery 2, whereas the lower of the two axes 16 shows a charging power which is dependent on a power connection and is able to be provided by the charging device 3.

The shaded area of FIG. 4 thus shows the range in which the charging by the presented method is particularly advantageous. The method is thus in particular active when the temperature of the traction battery 2, that is to say the battery temperature or a cell temperature, lies within a predefined target range. Furthermore, an outside temperature or ambient temperature should lie below a particular value, or the target range of the temperature is adapted in line with the outside temperature. The method can furthermore be advantageously used for a particular minimum value of the charging power and/or up to a particular cell temperature. Furthermore, an entry below the SoC A or an exit above the SoC B can be defined by the state of charge. Furthermore, by a trigger or with knowledge of the planned departure time, the method can be used such that the temperature of the traction battery 2 is located within the temperature range at the time of departure.

By way of the method, the cooling circuit 5, 7 can furthermore be operated as a heat pump. A target temperature of the high-voltage storage device can thus lie, for example, between 30 and 35 °C and the cooling device 6 can be operated accordingly depending on in which range the ambient temperature lies.

The presented method and the presented motor vehicle 1 thus give rise to particularly advantageous use of the waste heat. Some advantages are an increase in the temperature collective of the traction battery 2, the fact that heating of the storage device is avoided during and after the charging, and the fact that extra heating of the traction battery 2 to operating temperature is dispended with. Furthermore, an increase in the discharging power after the charging can be achieved.

For example, approximately 500 watts of waste heat can arise at the charging device 3 for a charging power of 11 kilowatt such that a considerably higher heating gradient of the storage device arises through the active supplying of the waste heat. The presented method and the presented motor vehicle 1 disclose both optimization of the AC charging for an electric vehicle and/or a hybrid vehicle.

### LIST OF REFERENCE SIGNS

1 Motor vehicle
2 Traction battery
3 Charging device
4 Ambient heat exchanger
5 Cooling circuit
6 Cooling device
7 Charging cooling circuit
8 Drive train
9 Charging heating element
10 Traction heating element
11 Valve
12 Pump
13 Interior heating element
14 Axis state of charge
15 Axis battery temperature
16 Axis charging power

1-10. (canceled)

11. A method for operating a motor vehicle having a traction battery, a charging device for charging the traction battery with alternating current, and an ambient heat exchanger of a cooling circuit of a cooling device configured to form one or more other cooling circuits, comprising:
forming a charging cooling circuit as one of the one or more other cooling circuits when the traction battery is being charged by the charging device;
absorbing, by the charging cooling circuit, heat from a charging heating element connected in a heat-conducting manner to the charging device; and
transferring the absorbed heat to a traction heating element connected in a heat-conducting manner to the traction battery, wherein there is no heat exchange with the ambient heat exchanger while the absorbed heat is transferred to the traction heating element.

12. The method according to claim 11, further comprising:
arranging an interior heating element in the charging cooling circuit with the charging heating element and the traction heating element when the traction battery is being charged.

13. The method according to claim 11, wherein:
the charging cooling circuit is formed based on an ambient temperature, a battery temperature, and/or an interior temperature.

14. The method according to claim 11, further comprising:
forming an extended charging cooling circuit from the charging cooling circuit and the ambient heat exchanger.

15. The method according to claim 14, wherein:
the charging cooling circuit and/or the extended charging cooling circuit are formed based on an ambient temperature, a battery temperature, and/or an interior temperature.

16. The method according to claim 14, wherein:
the charging cooling circuit and/or the extended charging cooling circuit are formed based on a state of charge of the traction battery.

17. The method according to claim 14, wherein:
the charging cooling circuit and/or the extended charging cooling circuit are formed based on a planned change in operating state of the motor vehicle.

18. The method according to claim 14, wherein:
the charging cooling circuit and/or the extended charging cooling circuit are formed based on a charging power provided by the charging device.

19. The method according to claim 14, wherein:
the charging cooling circuit and/or the extended charging cooling circuit are formed based on at least one cell spreading of at least one cell of the traction battery.

20. The method according to claim 14, further comprising:
forming the one or more other cooling circuits of the cooling device with one or more valves, wherein the one or more other cooling circuits comprise the charging cooling circuit and/or the extended charging cooling circuit.

21. A motor vehicle, comprising:
a traction battery;
a charging device for charging the traction battery with alternating current; and
an ambient heat exchanger of a cooling circuit of a cooling device configured to form one or more other cooling circuits, wherein when the traction battery is being charged by the charging device, the cooling device forms a charging cooling circuit that is configured to:
absorb heat from a charging heating element connected in a heat-conducting manner to the charging device, and
transfer the absorbed heat to a traction heating element connected in a heat-conducting manner to the traction battery, wherein there is no heat exchange with the ambient heat exchanger while the absorbed heat is transferred to the traction heating element.

22. The motor vehicle according to claim 21, further comprising:
an interior heating element arranged in the charging cooling circuit with the charging heating element and the traction heating element when the traction battery is being charged.

23. The motor vehicle according to claim 21, wherein:
the charging cooling circuit is formed based on an ambient temperature and/or a battery temperature and/or an interior temperature.

24. The motor vehicle according to claim 21, further comprising:
an extended charging cooling circuit comprising the charging cooling circuit and the ambient heat exchanger.

25. The motor vehicle according to claim 24, wherein the charging cooling circuit and/or the extended charging cooling circuit are formed based on an ambient temperature, a battery temperature, and/or an interior temperature.

26. The motor vehicle according to claim 24, wherein:
the charging cooling circuit and/or the extended charging cooling circuit are formed based on a state of charge of the traction battery.

27. The motor vehicle according to claim 24, wherein:
the charging cooling circuit and/or the extended charging cooling circuit are formed based on a planned change in operating state of the motor vehicle.

28. The motor vehicle according to claim 24, wherein:
the charging cooling circuit and/or the extended charging cooling circuit are formed based on a charging power provided by the charging device.

29. The motor vehicle according to claim 24, wherein:
the charging cooling circuit and/or the extended charging cooling circuit are formed based on at least one cell spreading of at least one cell of the traction battery.

30. The motor vehicle according to claim 24, further comprising:
one or more valves configured to form the one or more other cooling circuits of the cooling device, the one or more other cooling circuits comprising the charging cooling circuit and/or the extended charging cooling circuit.
